(19) United States
(12) Patent Application Publication
(10) Pub. No.: US 2023/0316134 A1
(43) Pub. Date: Oct. 5, 2023

(54) Source Selection based on Diversity for Machine Learning

(71) Applicant: Telefonaktiebolaget LM Ericsson (publ), Stockholm (SE)

(72) Inventors: Andreas Johnsson, Uppsala (SE); Masoumeh Ebrahimi, Solna (SE); Farnaz Moradi, Stockholm (SE); Hannes Larsson, Solna (SE); Jalil Taghia, Stockholm (SE)

(21) Appl. No.: 18/024,903

(22) PCT Filed: Sep. 17, 2021
(86) PCT No.: PCT/SE2021/050898

§ 371 Date: Mar. 6, 2023

Related U.S. Application Data
(60) Provisional application No. 63/080,371, filed on Sep. 18, 2020.

(51) Int. Cl. G06N 20/00

(52) U.S. Cl. CPC G06N 20/00

(57) ABSTRACT

A method for machine-learning adaptation comprises identifying (110) a plurality of machine-learning source domain candidates and calculating (120), for each of the identified machine-learning source domain candidates, a diversity metric, where the diversity metric represents a marginalized measure of sample diversity of the respective machine-learning source domain candidate. The method further comprises selecting (130) the identified machine-learning source domain candidates having a highest diversity metric among the calculated diversity metrics and applying (140) the selected machine-learning source domain candidate to a target domain in a new or changed execution environment. The diversity metric may be calculated based on information theoretic measures, for example, such as based on a one-parameter measure of generalized entropy.

### TECHNICAL FIELD

The present application relates to machine learning, e.g., as applied to management of telecommunications networks.

### BACKGROUND

Management of telecommunication systems is challenging, due to component and service complexity, heterogeneity, scale, and dynamicity. Promising management approaches based on machine learning are being developed in academia and in industry. However, a key challenge in data-driven model creation is the difficulty of maintaining the accuracy of a machine-learning model over time, as well as reusing knowledge learned for one type of execution environment.

In recent years, transfer learning has received considerable attention, specifically in areas such as image, video, and sound recognition. In traditional machine learning, each task is learned from scratch, using training data obtained from a domain and making predictions for data from the same domain. However, sometimes there is an insufficient amount of data for training in the domain of interest. In these cases, transfer learning can be used to transfer knowledge from a domain where sufficient training data is available to the domain of interest, to improve the accuracy of the machine learning task.

Transfer learning is defined as follows. Given a source domain D_{S} and learning task T_{S} and a target domain D_{T} and learning task T_{T}, transfer learning aims to help improve the learning of the target predictive function ƒ_{T}(⋅) in D_{T} using the knowledge in D_{S} and T_{S}, where D_{S} D_{T}, or T_{S}≠T_{T}.

Transfer learning methods can be divided into two main categories: homogeneous and heterogeneous. In homogeneous transfer learning, the feature spaces in the source and target domains are the same, while in heterogeneous transfer learning the source and target domains can have different feature spaces.

In a telecommunications/cloud environment, a source domain may refer to a machine-learning (ML) model trained for a specific type of execution environment, e.g., a virtual machine (VM) executing with a specific configuration, whereas the target domain might correspond to a scaled or migrated version of the same environment.

In certain applications, there may be limited understanding of the target domain, due to the lack of availability of data samples that are representative of the domain, for example, because of difficulties in collecting data, limitations in storing data, and/or because of the dynamic nature of the execution environment in the target domain.

Transfer learning is an approach that aims at addressing the problem by incorporating knowledge gained from other source domains into the target domain. The transferred knowledge from other sources should be relevant to the target domain. Where there are multiple choices available for the source domain, this implies a need for source selection, where the goal is identifying the source domain that is the most relevant to the target domain, i.e., identifying the source domain that can be most readily applied to the target domain.

A number of techniques for selecting a source domain for transfer learning have been proposed. Bascol et al. (2019) proposed a source-selection strategy based on distance between source and target domains. They compared various distance metrics constructed from chi-square divergence, Maximum Mean Discrepancy, Wassertein distance and Kullback Leibler divergence. All of these distance metrics quantify the similarity between domains.

Bao et al. (2019) introduced a similarity-based metric between domain tasks, named the H-score, for determining the performance of transferred representations.

Jamshidi et al. (2018) introduced a method for guided sampling. This sampling exploits knowledge from various source domains whose data distributions are similar to the target domain.

In Xiong et al. (2020), the entropy of the data samples in the target domain was compared against the sources based on the hypothesis that selected source data share a similar distribution to the target domain data.

Nguyen et al. (2020) proposed a measure of transferability, named log Expected Empirical Prediction (LEEP). This technique relies on the data in the target domain. LEEP is related to the negative conditional entropy measure introduced in Tran et al. (2019). Conditional entropy is closely related to the Kullback-Leibler divergence, which can be seen as a similarity measure.

Imai et al. (2020) proposed a technique for layer-by-layer knowledge-selection-based transfer learning, named Stepwise PathNet. The Stepwise PathNet knowledge selection is based on minimizing the cross-entropy loss function. Cross entropy is a measure of similarity.

As seen in the brief description of existing techniques for source domain selection described above, the primary objective of these techniques is to find the source domain that is the most similar to the target domain, by relying on statistical similarity between domains. There are two main issues that arise with these techniques, however. First, they implicitly impose lower-bound constraints on the availability and quality of data in the target domain. Second, they can impose unachievable demands on the availability of computational power in the execution environment (deployment environment) of the target domain.

For at least these reasons, improved techniques for source domain selection in the context of transfer learning are needed.

### SUMMARY

Disclosed herein are techniques for automated source-selection for transfer learning, with applications for telecom systems. Contrary to existing technologies for source selection, which are built on the underlying idea of measuring similarities between the domains, the techniques disclosed herein are built on the idea of encouraging diversity. Thus, this disclosure first introduces a measure of diversity based on the information theoretical concept of generalized entropy, and next introduces a method for source selection that uses this measure in order to automatically identify candidate sources for the target domain.

An example method as disclosed herein for machine-learning adaptation comprises identifying a plurality of machine-learning source domain candidates and calculating, for each of the identified machine-learning source domain candidates, a diversity metric, where the diversity metric represents a marginalized measure of sample diversity of the respective machine-learning source domain candidate. The method further comprises selecting the identified machine-learning source domain candidates having a highest diversity metric among the calculated diversity metrics and applying the selected machine-learning source domain candidate to a target domain in a new or changed execution environment. The diversity metric may be calculated based on information theoretic measures, for example, such as based on a one-parameter measure of generalized entropy.

Example apparatuses configured to carry out a method like that summarized above, and/or variants thereof, are also described below. Other embodiments include computer programs and carriers of computer programs configured to carry out any of these methods.

Advantages that may be obtained by various embodiments of the techniques disclosed herein include that the source selection methods describe herein are free of any constraints on the data in the execution environment of the target domain. As a practical matter, this means that the method can be applied in scenarios where there are a few or no data samples available in the target domain. An example of this is deployment of a virtual network function in a new execution environment. Other advantages will be apparent from the detailed description provided below and the accompanying figures.

### BRIEF DESCRIPTION OF THE FIGURES

FIG. 1 is a process flow diagram illustrating an example method according to some of the techniques disclosed herein.

FIG. 2 illustrates functional components of an apparatus configured to carry out any of the presently disclosed techniques.

FIG. 3 illustrates an example apparatus according to some of the embodiments disclosed herein.

FIG. 4 illustrates the Tsallis entropy across a range of a, for each of four simulated source domains.

FIG. 5 illustrates diversity metrics for the four simulated source domains, calculated according to the presently disclosed techniques.

FIG. 6 is a block diagram illustrating an example server node according to some embodiments of the presently disclosed invention.

### DETAILED DESCRIPTION

As noted above, existing techniques for source domain selection for transfer learning rely on measures of similarity between a candidate source domain and the target domain. In scenarios where data in the target domain are scarce or data samples are poorly representative of the domain, however, one cannot reliably compute the similarity between domains (for example where we have a few samples in the target domain or even no samples at all). If not explicitly, these techniques implicitly enforce constraints on the target domain. These constraints are the size of data and the quality of data.

Given that transfer learning is of utmost relevance in cases where there are inherently limited data in the target domain, there is a need for developing source selection techniques that are not reliant on the similarity between the domains. In other words, there is a need for developing methods that are applicable in cases where there are potentially only a few or even no samples in the target domain.

Conversely, when there are enough representative data samples available in the target domain to reliably evaluate the similarity between the target domain and a candidate source domain, the potential benefits of transfer learning are limited. The main application domain of transfer learning is scenarios where we do not have enough representative data in the target domain. Thus, imposing any constraints on the data in the target domain can greatly limit application of transfer learning where it is most beneficial.

Another issue with existing techniques for source domain selection is that they imply constraints on the availability of sufficient computational resources in the execution environment.

To measure the similarity between the target domain and the source domains, existing techniques require statistical modelling of data in the target domain, which implicitly imposes a constraint on the need for availability of sufficient computational resources in the execution environment. In some applications, data in the target domain can be high-dimensional, containing feature attributes in quantities on the order of thousands. Modelling such data requires access to substantial computational resources.

The need for statistical modelling of data also means additional compactional time. This can be problematic in highly dynamic settings where the execution environment changes rapidly over time, and where there are many sources from which to choose.

Various embodiments of the techniques described herein address these problems. More particularly, techniques for automated source-selection for transfer learning, with applications for telecom systems, are described in detail herein. Contrary to existing technologies for source selection, which are built on the underlying idea of measuring similarities between the domains, the techniques disclosed herein are built on the idea of encouraging diversity.

As will be shown below, unlike with existing methods, the source selection techniques described herein are free of any constraints on the data in the execution environment of the target domain. As a practical matter, this means that the method can be applied in scenarios where there are a few or no data samples available in the target domain. An example of this is deployment of a virtual network function in a new execution environment.

The proposed measure of diversity is general and provides a unified definition of diversity in terms of information theoretic concept of entropy. The measure covers a large family of existing generalized entropies and any other future formulations of the generalized entropy that satisfies the necessary conditions discussed in this invention.

Another advantage of some embodiments of the presently disclosed techniques is that they are scalable to a large number of source domain candidates. To select a source out of a dictionary of candidates, it is only necessary to compare diversity index values of source candidates with one another, or with a threshold. This numerical comparison requires limited compute resources, which grow only linearly with the number of sources. This can be especially important when the source selection has to be done in a timely manner.

The techniques described herein can be deployed in applications where the execution environment in the target domain undergoes rapid changes over time. With detection of a change in the execution environment, the method automatically re-selects the source domain that is most relevant to the target domain.

In the following discussion, source domain selection techniques are described in the context of transfer learning, with particular application to telecommunications applications. It should be appreciated, however, that these techniques are not strictly limited to transfer learning, but might be applied in other contexts, e.g., in the context of federated machine learning. Further, while these techniques may be especially applicable in the context of telecommunications networks, they are not limited to that application environment either.

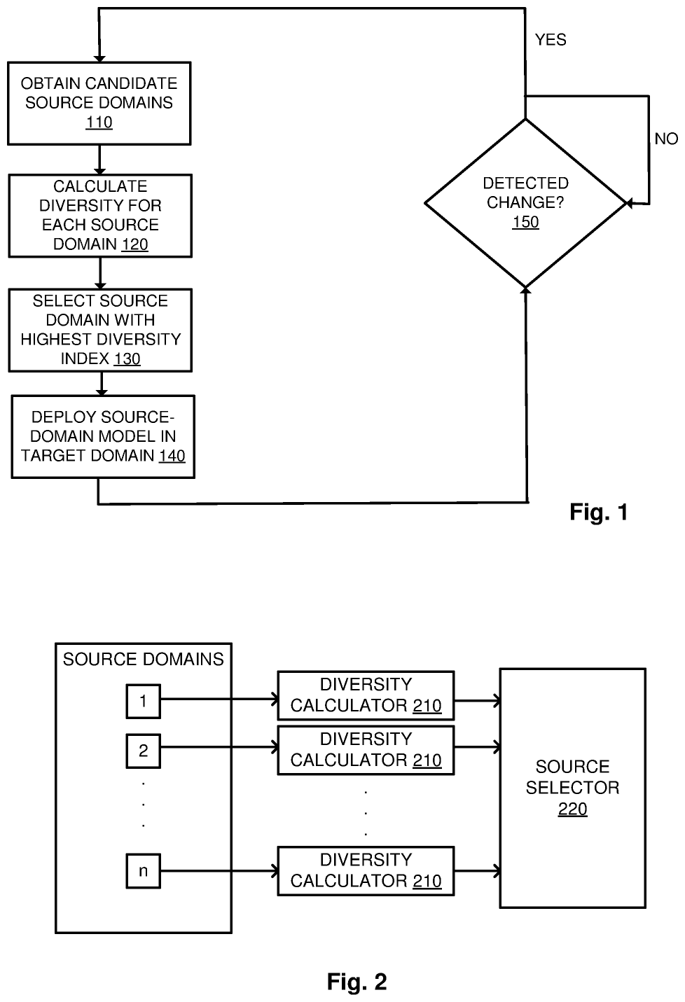

FIG. 1 illustrates an example method according to several embodiments of the presently disclosed techniques. This method might be performed in a network node in a telecommunications network, for example, e.g., in a server node.

As shown at block 110, the method includes the step of obtaining a list of candidate source domains. This may be done, for example, by selecting candidate source domains that are reflective of the current execution environment in the target domain, for example, e.g., by selecting candidate source domains with similar feature spaces to the target domain. The details of how this list of candidate source domains is obtained are not important to understanding the diversity-based selection of one or more of these candidate source domains for application to the target domain, and thus are not discussed further.

Next, as shown at block 120, a diversity metric, or diversity index, is calculated for each of the plurality of candidate source domains, based on the data samples of the respective candidate source domain. Details of this calculation are provided below. In short, however, this diversity metric represents a marginalized measure of sample diversity of the respective candidate source domain and may be calculated based on information theoretic measures, such as a one-parameter measure of generalized entropy.

Next, as shown at block 130, the candidate source domain having the highest diversity metric/index value is selected. In some embodiments, multiple candidate source domains may be selected at this step, e.g., by selecting a certain number of candidate source domains having the highest diversity metric or by selecting each candidate source domain having a diversity metric greater than a predetermined threshold.

As shown at block 140, the method continues with deployment of the source-domain model (or models) in the target domain. In other words, the model developed in the selected source domain is applied to the relevant task or tasks in the target domain.

The steps shown at blocks 110-140 may be repeated, in some embodiments or instances, such as when there is a significant change in the execution environment, e.g., a change in available features, a change in tasks, and/or a change in operating resources. This is shown at block 150 in FIG. 1, where a change may be detected, triggering a restart of the illustrated method. It will be appreciated that upon a repeat of step 110, the same or different candidate source domains may appear in the list from which a source domain is selected. Different candidate source domains may result when the detected change is in the feature space of the target domain, for instance. However, even if the candidate source domains are the same, their underlying statistics may have changed since the previous time a source domain was selected, due to ongoing changes in the environment where the source domain is located. Thus, repeating steps 110-140 even with the same list of candidate source domains may result in a different selection.

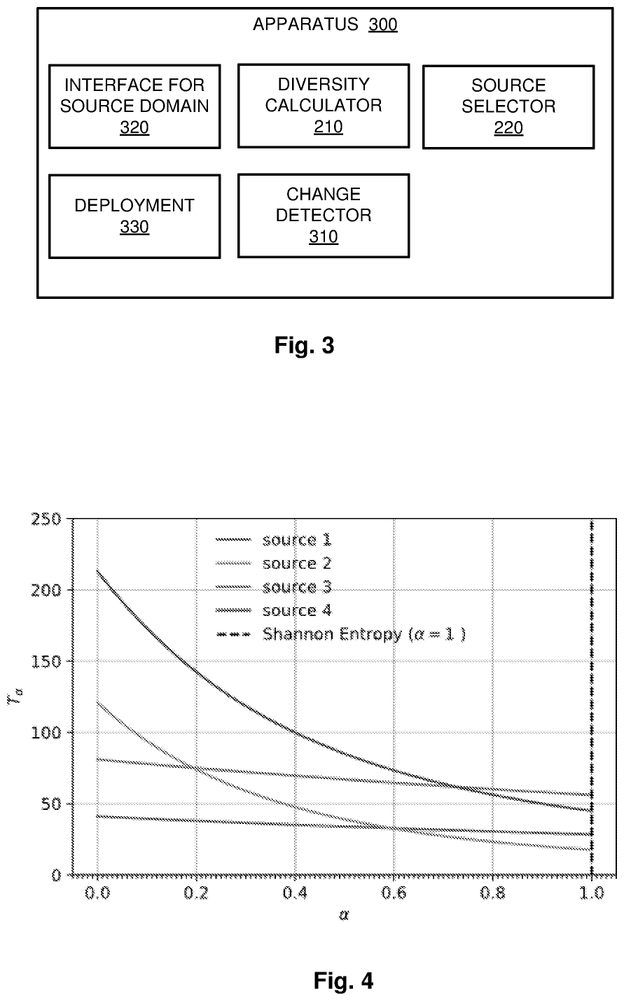

FIG. 2 is a block diagram illustrating functional components configured to carry out at least parts of a method like that shown in FIG. 2. Likewise, FIG. 3 illustrates components of a source selection apparatus 300. Both figures may be understood as illustrating a conceptual representation of functional elements arranged to carry out the presently disclosed techniques, but the illustrated diversity calculators 210, source selector 220, change detector 310, etc., may also be understood to correspond to software modules or instances executing on appropriate processing circuitry, according to some embodiments. Details of the functionality of these modules are provided below; these details should be understood as applying to the corresponding operations illustrated in FIG. 1, as well.

The key modules in FIGS. 2 and 3 are the diversity calculator 210, the source selector 220, and the change detector module 310. Example details of the functionality of these modules are provided below.

The diversity calculator 210 takes as its input the data samples from a source domain and computes a marginalized measure of diversity. This may be computed according to:

I_{diversity}=∫₀¹GE(α)dα, (1)

where GE(α) is a generalized entropy of order α.

The integral in Equation (1) can be computed using standard numerical techniques. The diversity index or, alternatively, diversity metric introduced in Equation (1) is a marginalized quantity. More precisely, in computation of this measure, uncertainties around a are marginalized out. This is important, since, in practice, the challenge is that the best choice of a is not known. Hence, marginalization is a simple yet effective way of addressing this challenge. Further below, an example illustrating the importance of marginalization is provided.

The example formulation of diversity index shown here contains all one-parameter family of generalized entropies, referred here to as the a-family of generalized entropies. A generalized entropy belongs to the a-family provided that it satisfies the following necessary conditions:
for α=1, it converges to the Shannon entropy;
it is a smooth function (differentiable everywhere) for all 0<α<1;
it is monotonically decreasing function in a;
as α→∞, its entropy approaches zero, that is: GE(α)→0.
   Examples of generalized entropies that meet the above conditions are:
the Renyi entropy of order α;
the Havrda-Charvat entropy of order α; and
the Tsallis entropy of order α.
   Other information-theoretic metrics for determining diversity of a source data trace may be utilized in other embodiments.

The source selector 220 takes as its input all diversity index values computed by the diversity calculators 210. It then outputs the source domain(s) most relevant to the target domain by choosing the source domain having the highest diversity index, or a set of sources with a diversity index above a threshold. This threshold can be predetermined, e.g., as a static value or computed based on previous experience.

In some embodiments, the change detector module 310 (not shown in FIG. 2 but illustrated in FIG. 3) monitors the execution environment in the target domain. Aspects of the target domain such as the available features for modeling, the modeling tasks, and/or the resources available to the modeling may be among those that are monitored by the change detector. If a significant enough change is detected, the module will trigger reconsideration of the choice of source domain. That is, the processing operations go back to step 110 shown in FIG. 1.

For a cloud-based execution environments such as virtual machines (VMs) and containers, a severe change could be manifested by a scaling or migration actions triggered by the orchestration engine whereby the computational or networking resources assigned to the virtualized entity changes. Another type of change relates a change in the data collection system, for example if the number of features available for an execution environment is altered. Note that this disclosure does not propose specific methods for determining severity of changes, as there are several papers discussing this in academia and industry, and specifics of this evaluation are not necessary for a full understanding of the presently disclosed invention.

Other components of the apparatus 300 shown in FIG. 3 include an interface 320 to receive the source-domain information, e.g., from another network node, and a deployment module 330 that can send the selected model to the target domain, e.g., again on another network node. It should be appreciated that the pictured components may be implemented on a single physical apparatus, or divided among multiple devices, e.g., among multiple server nodes.

Summarizing the general technique once again, some embodiments of the presently disclosed techniques may start with a “step 0,” or an initialization step, in which a generalized entropy of order α is selected, which satisfies the necessary conditions described above. Note that in practice, this step may be performed by a system designer, prior to deployment of an execution environment, and thus may not be performed by the same platform or platforms that perform the other steps of the techniques described here.

In a “step 1,” a list of all source domain candidates reflective of the current execution environment in the target domain is obtained. The candidates can be identified, for example, by following a set of manually constructed rules that determines whether the features and tasks of the domains match. This may be an automated process. In a step 2, the diversity calculator module 210 is applied to each source domain in the list of candidate source domains. The output is a set of diversity index values—a scalar value per candidate source domain. In a step 3, the source selector module 310 is applied to the diversity index values or diversity metrics. In some embodiments, the output of this module is the single most relevant source to the target domain at the given execution environment, i.e., the candidate source domain having the highest diversity metric. In other embodiments, the output of this module may be a list of relevant sources to the target domain, e.g., a predetermined number of candidate source domains having the highest diversity metric values, or all candidate source domains having a diversity metric higher than a predetermined threshold.

At a “step 4,” the model of the selected candidate source domain is deployed/applied in the target domain for usage and further training. In a “step 5,” which may not be present in all implementations or instances, the change detector 310 monitors the execution environment of the target domain. If a significant enough change is detected, steps 1 to 3 are repeated for a new list of source domain candidates, reflective of the change in the execution environment.

The present inventors have performed proof-of-concept experiments in support of the disclosed techniques. The motivation behind design of the disclosed diversity measures is demonstrated through a controlled experiment.

Regarding a justification for the use of a marginalized measure of diversity as a metric/index for selecting a candidate source domain, a synthetic experiment first illustrates challenges in defining a diversity measure based on information theoretic concept of entropy. Then, indicative results in support of this marginalized measure of diversity are provided.

Consider four sources constructed with various degrees of diversities such that the relative extent of their sample diversities are known:

Source 1<Source 2<Source 3<Source 4.

In this experiment, we use Tsallis entropy as an example of a generalized entropy that satisfies the necessary conditions of a-family of entropies discussed above. FIG. 4 illustrates Tsallis entropy values across different a's, for each of these sources. Let the notation T_{α}(Source) denote the value of Tsallis entropy evaluated at a for a given Source. If one defines the diversity in terms of entropy at a given a, evaluation of the Tsallis entropy at different a would result in different ordering of sources. For example:

At α=1, the Tsallis entropy reduces to the Shannon entropy. From FIG. 4, we have:

T_{α=1}(Source 3)>T_{α=1}(Source 4)>T_{α=1}(Source 1)>T_{α=1}(Source 2).

At α=0.1, we have:

T_{α=0.1}(Source 4)>T_{α=0.1}(Source 2)>T_{α=0.1}(Source 3)>T_{α=0.1}(Source 1).

At α=0.4, we have:

T_{α=0.4}(Source 4)>T_{α=0.4}(Source 3)>T_{α=0.4}(Source 2)>T_{α=0.4}(Source 1).

Among the above three choices of a, this is only α=0.4 which recovers the correct ordering of the sources with respect to their underlying diversity.

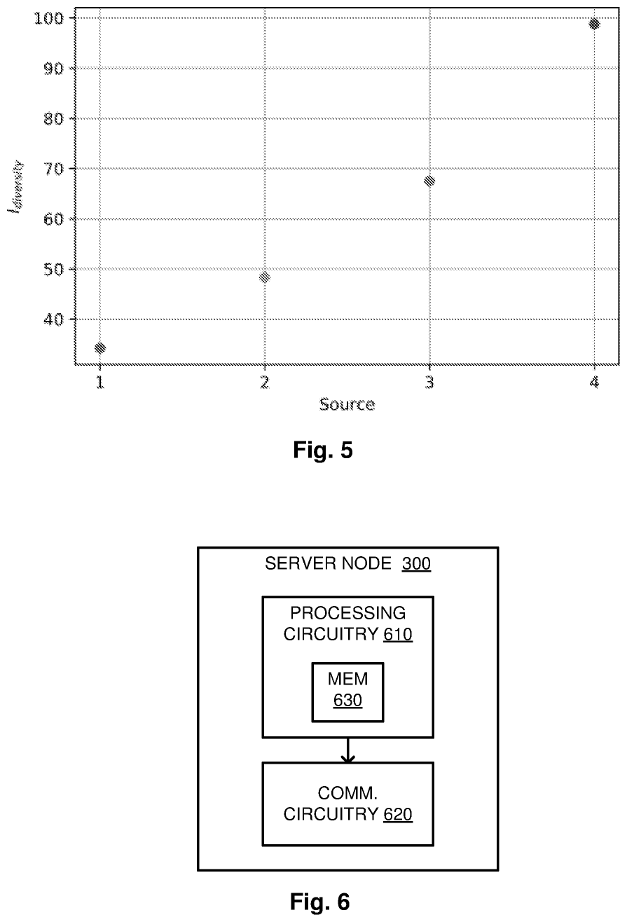

The main challenge in real world applications is that the correct a is generally unknown. According to the techniques detailed above, a marginalized entropy is used as the measure of diversity index. FIG. 5 shows the marginalized diversity index computed using Equation (1) for Tsallis entropy, for each of sources 1-4. In the derivation of the marginalized diversity index, the uncertainty around a is marginalized out. As seen in FIG. 5:

I(Source 4)>I(Source 3)>I(Source 2)>I(Source 1),

where I indicates the diversity index computed from Equation (1) for Tsallis entropy. This diversity index thus correctly identifies the exact ordering of the sources.

Embodiments of the presently disclosed techniques and apparatuses thus include methods for machine-learning adaptation. According to at least one example, such a method comprises the step of identifying a plurality of machine-learning source domain candidates, e.g., as shown at block 110 of FIG. 1. In some embodiments, this identifying of the plurality of machine-learning source domain candidates may comprise comparing a feature space for each machine-learning source domain candidate to a feature space of the target domain, for example.

The method further comprises the step of calculating, for each of the identified machine-learning source domain candidates, a diversity metric, e.g., as shown at block 120 of FIG. 1. This diversity metric representing a marginalized measure of sample diversity of the respective machine-learning source domain candidate. Note that the terms “diversity metric” and “diversity index” are used interchangeably here.

The method further comprises the step of selecting at least the identified machine-learning source domain candidates having a highest diversity metric among the calculated diversity metrics, e.g., as shown at block 130 of FIG. 1. The method still further comprises applying the selected machine-learning source domain candidate to a target domain in the new or changed execution environment, e.g., as shown at block 140 of FIG. 1.

In some embodiments, as was discussed above, the diversity metric is calculated based on information theoretic measures. The diversity metric may be calculated based on a one-parameter measure of generalized entropy, for example. The one-parameter may be any of the Rényi entropy, the Havrda-Charvat entropy, or the Tsallis entropy, in various embodiments. Other generalized entropy measures may be used, in other embodiments.

In some embodiments, the selecting of a candidate source domain may comprise selecting a plurality of machine-learning source domain candidates having respective diversity metrics above a predetermined threshold. In these embodiments each of the selected machine-learning source domain candidate may be applied to the target domain in the new or changed execution environment.

In some embodiments, the calculating, selecting, and applying steps described herein may comprise transfer learning performed in response to detecting a change in the execution environment, e.g., as shown at block 150 in FIG. 1. In some of these embodiments, detecting the change in the execution environment may comprise detecting a change in feature space in the target domain. In some of these or in other embodiments, detecting the change in the execution environment may comprise detecting a change in resources available in the execution environment.

It should be appreciated that the techniques described herein are not limited to use in transfer learning. In some embodiments, for example, the calculating, selecting, and applying steps described above may be performed as part of inclusion in a federation for federated machine learning. In some embodiments, the execution environment comprises one or more servers in a telecommunications network. But, these techniques may likewise be applied in other contexts or applications.

The techniques described herein may be realized in or implemented on a server node, e.g., a server node adapted to: identify a plurality of machine-learning source domain candidates; calculate, for each of the identified machine-learning source domain candidates, a diversity metric, the diversity metric representing a marginalized measure of diversity of the respective machine-learning source domain candidate; select the identified machine-learning source domain candidates having a highest diversity metric among the calculated diversity metrics; and apply the selected machine-learning source domain candidate to a target domain in the execution environment. All of the variations described above for the disclosed techniques and methods are likewise applicable to such a server node.

FIG. 6 illustrates an example server node 600, comprising communication circuitry 620 configured for communication with one or more other nodes in a network, and processing circuitry 610. In some embodiments, processing circuitry 610 is configured to: identify a plurality of machine-learning source domain candidates; calculate, for each of the identified machine-learning source domain candidates, a diversity metric, the diversity metric representing a marginalized measure of sample diversity of the respective machine-learning source domain candidate; select the identified machine-learning source domain candidates having a highest diversity metric among the calculated diversity metrics; and apply the selected machine-learning source domain candidate to a target domain in the new or changed execution environment. Once more, all of the variations described above for the disclosed techniques and methods are likewise applicable to such a server node 600.

Processing circuitry 610 may comprise one or more processors and/or other hardware configured to carry out program instructions stored in a memory 630. Other embodiments of the presently disclosed invention thus comprise a computer program comprising instructions which, when executed by at least one processor of a server, causes the server to carry out any of the methods described herein. Likewise, embodiments also include a carrier containing such a computer program, wherein the carrier is one of an electronic signal, optical signal, radio signal, or computer readable storage medium.

More generally, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Communication circuitry 620 like that shown in FIG. 6 may be configured to transmit and/or receive information to and/or from one or more other nodes, e.g., via any communication technology. Such communication may occur via one or more antennas that are either internal or external to the server node 600, or via hardwired network connections.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Thus, described herein is an automated source-selection method for transfer learning with applications for telecom systems. Contrary to the existing technologies for source selection, that are built on the underlying idea of measuring similarities between the domains, the methods for source selection in transfer learning disclosed herein are built on the idea of encouraging diversity. A measure of diversity based on the information theoretical concept of generalized entropy was introduced, as was a method for source selection that uses this measure in order to automatically identify candidate sources for the target domain

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### Example Embodiments

In view of the disclosure presented above, it should be appreciated that embodiments of the disclosed techniques and apparatuses include, but are not limited to the following enumerated examples:

(i) A method for machine-learning domain adaptation in an execution environment, the method comprising:
identifying a plurality of machine-learning source domain candidates;
calculating, for each of the identified machine-learning source domain candidates, a diversity metric, the diversity metric representing a marginalized measure of sample diversity of the respective machine-learning source domain candidate; selecting the identified machine-learning source domain candidate having a highest diversity metric among the calculated diversity metrics; and applying the selected machine-learning source domain candidate to a target domain in the execution environment.
   (ii). The method of example embodiment (i), wherein the diversity metric is calculated based on information theoretic measures.
   (iii). The method of example embodiment (ii), wherein the diversity metric is calculated based on a one-parameter measure of generalized entropy.
   (iv). The method of example embodiment (iii), wherein the one-parameter measure is selected from the following:
the Rényi entropy;
the Havrda-Charvat entropy; and
the Tsallis entropy.
   (v). The method of example embodiment (i) or (ii), wherein said selecting comprises selecting a plurality of machine-learning source domain candidates having respective diversity metrics above a predetermined threshold, and wherein said applying comprises applying each of the selected machine-learning source domain candidate to the target domain in the execution environment.
   (vi). The method of any of example embodiments (i)-(v), wherein said calculating, selecting, and applying comprises transfer learning performed in response to detecting a change in the execution environment.
   (vii). The method of example embodiment (vi), wherein detecting the change in the execution environment comprises detecting a change in feature space in the target domain.
   (viii). The method of example embodiment (vi), wherein detecting the change in the execution environment comprises detecting a change in resources available in the execution environment.
   (ix). The method of any of example embodiments (i)-(v), wherein said calculating, selecting, and applying is performed as part of inclusion in a federation for federated machine learning.
   (x). The method of any of example embodiments (i)-(ix), wherein identifying the plurality of machine-learning source domain candidates comprises comparing a feature space for each machine-learning source domain candidate to a feature space of the target domain.
   (xi). The method of any of example embodiments (i)-(x), wherein the execution environment comprises one or more servers in a telecommunications network.
   (xii). A server node adapted to:
identify a plurality of machine-learning source domain candidates;
calculate, for each of the identified machine-learning source domain candidates, a diversity metric, the diversity metric representing a marginalized measure of diversity of the respective machine-learning source domain candidate;
select the identified machine-learning source domain candidates having a highest diversity metric among the calculated diversity metrics; and
apply the selected machine-learning source domain candidate to a target domain in the execution environment.
   (xiii). The server node of example embodiment (xii), wherein the server is further adapted to carry out a method according to any of example embodiments (ii)-(x).
   (xiv). A server node, comprising:
communication circuitry configured for communication with one or more other nodes in a network; and
processing circuitry configured to:
   identify a plurality of machine-learning source domain candidates;
   calculate, for each of the identified machine-learning source domain candidates, a diversity metric, the diversity metric representing a marginalized measure of sample diversity of the respective machine-learning source domain candidate;
   select the identified machine-learning source domain candidates having a highest diversity metric among the calculated diversity metrics; and
   apply the selected machine-learning source domain candidate to a target domain in the execution environment.
      (xv). The server node of example embodiment (xiv), wherein the server is further adapted to carry out a method according to any of example embodiments (ii)-(x).
      (xvi). A computer program comprising instructions which, when executed by at least one processor of a server, causes the server to carry out the method of any of example embodiments (i)-(x).
      (xvii). A carrier containing the computer program of example embodiment (xvi), wherein the carrier is one of an electronic signal, optical signal, radio signal, or computer readable storage medium.

### REFERENCES

[Xiong2020] Xiong, F., Barker, J., Yue, Z., & Christensen, H. (2020). Source Domain Data Selection for Improved Transfer Learning Targeting Dysarthric Speech Recognition. ICASSP 2020-2020 IEEE International Conference on Acoustics, Speech and Signal Processing (ICASSP), 7424-7428.
[Nguyen2020] Nguyen, C. V., Hassner, T., Archambeau, C., & Seeger, M. (2020). LEEP: A New Measure to Evaluate Transferability of Learned Representations. ArXiv, abs/2002.12462.
[Tran2019] Tran, A., Nguyen, C. V., & Hassner, T. (2019). Transferability and Hardness of Supervised Classification Tasks. 2019 IEEE/CVF International Conference on Computer Vision (ICCV), 1395-1405.
[Bascol2019] Bascol, K., Emonet, R., & Fromont, E. (2019). Improving Domain Adaptation by Source Selection. 2019 IEEE International Conference on Image Processing (ICIP), 3043-3047.
[Bao2019] Bao, Y., Li, Y., Huang, S., Zhang, L., Zheng, L., Zamir, A., & Guibas, L. (2019). An Information-Theoretic Approach to Transferability in Task Transfer Learning. 2019 IEEE International Conference on Image Processing (ICIP), 2309-2313.
[Jamshidi2018] Jamshidi, P., Velez, M., Kaestner, C., & Siegmund, N. (2018). Learning to sample: exploiting similarities across environments to learn performance models for configurable systems. Proceedings of the 2018 26th ACM Joint Meeting on European Software Engineering Conference and Symposium on the Foundations of Software Engineering.
[Imai2020] Imai, S., Kawai, S., & Nobuhara, H. (2020). Stepwise PathNet: a layer-by-layer knowledge-selection-based transfer learning algorithm. Scientific Reports, 10.

1-18. (canceled)

19. A method for machine-learning adaptation, the method comprising:
identifying a plurality of machine-learning source domain candidates;
calculating, for each of the identified machine-learning source domain candidates, a diversity metric, the diversity metric representing a marginalized measure of sample diversity of the respective machine-learning source domain candidate;
selecting the identified machine-learning source domain candidate having a highest diversity metric among the calculated diversity metrics; and
applying the selected machine-learning source domain candidate to a target domain in a new or changed execution environment.

20. The method of claim 19, wherein the diversity metric is calculated based on information theoretic measures.

21. The method of claim 20, wherein the diversity metric is calculated based on a one-parameter measure of generalized entropy.

22. The method of claim 21, wherein the one-parameter measure is selected from the following:
the Rényi entropy;
the Havrda-Charvat entropy; and
the Tsallis entropy.

23. The method of claim 19, wherein said selecting comprises selecting a plurality of machine-learning source domain candidates having respective diversity metrics above a predetermined threshold, and wherein said applying comprises applying each of the selected machine-learning source domain candidates to the target domain.

24. The method of claim 19, wherein said calculating, selecting, and applying comprises transfer learning performed in response to detecting a change in the execution environment of the target domain.

25. The method of claim 24, wherein detecting the change in the execution environment comprises detecting a change in feature space in the target domain.

26. The method of claim 24, wherein detecting the change in the execution environment comprises detecting a change in a machine-learning task in the target domain.

27. The method of any one of claim 24, wherein detecting the change in the execution environment comprises detecting a change in resources available in the execution environment.

28. The method of claim 19, wherein said calculating, selecting, and applying is performed as part of inclusion in a federation for federated machine learning.

29. The method of claim 19, wherein identifying the plurality of machine-learning source domain candidates comprises comparing a feature space for each machine-learning source domain candidate to a feature space of the target domain.

30. The method of claim 19, wherein the execution environment comprises one or more servers in a telecommunications network and applying the selected machine-learning source domain candidate comprises using the selected machine-learning source domain candidate for management of one or more telecommunications tasks in the telecommunications network.

31. A server node, comprising:
communication circuitry configured for communication with one or more other nodes in a network; and
processing circuitry configured to:
identify a plurality of machine-learning source domain candidates;
calculate, for each of the identified machine-learning source domain candidates, a diversity metric, the diversity metric representing a marginalized measure of sample diversity of the respective machine-learning source domain candidate;
select the identified machine-learning source domain candidate having a highest diversity metric among the calculated diversity metrics; and
apply the selected machine-learning source domain candidate to a target domain in a new or changed execution environment.

32. The server node of claim 31, wherein the diversity metric is calculated based on information theoretic measures.

33. The server node of claim 32, wherein the diversity metric is calculated based on a one-parameter measure of generalized entropy.

34. The server node of claim 33, wherein the one-parameter measure is selected from the following:
the Rényi entropy;
the Havrda-Charvat entropy; and
the Tsallis entropy.

35. The server node of claim 31, wherein the processing circuitry is configured to select a plurality of machine-learning source domain candidates having respective diversity metrics above a predetermined threshold and to apply each of the selected machine-learning source domain candidates to the target domain.

36. The server node of claim 31, wherein the processing circuitry's performance of the calculating, selecting, and applying comprises transfer learning performed in response to detecting a change in the execution environment of the target domain.

37. The method of claim 36, wherein detecting the change in the execution environment comprises at least one of any of:
detecting a change in feature space in the target domain;
detecting a change in a machine-learning task in the target domain; and
detecting a change in resources available in the execution environment.

38. A non-transitory computer-readable medium comprising, stored thereupon, a computer program comprising instructions configured to cause a server executing the instructions to:
identify a plurality of machine-learning source domain candidates;
calculate, for each of the identified machine-learning source domain candidates, a diversity metric, the diversity metric representing a marginalized measure of sample diversity of the respective machine-learning source domain candidate;
select the identified machine-learning source domain candidate having a highest diversity metric among the calculated diversity metrics; and
apply the selected machine-learning source domain candidate to a target domain in a new or changed execution environment.
